(19) United States
(12) Patent Application Publication
(10) Pub. No.: US 2014/0374931 A1
(43) Pub. Date: Dec. 25, 2014

(54) METHOD FOR PRODUCING TRANSPARENT CERAMIC OBJECTS BY MEANS OF FLUIDIZED BED GRANULATION

(71) Applicant: CERAMTEC-ETEC GMBH, Lohmar (DE)

(72) Inventor: Lars Schnetter, Wimbach (DE)

(73) Assignee: CERAMTEC-ETEC GMBH, Lohmar (DE)

(21) Appl. No.: 14/357,472

(22) PCT Filed: Nov. 12, 2012
(86) PCT No.: PCT/EP2012/072344

§ 371 Date: Jul. 22, 2014

(30) Foreign Application Priority Data
Nov. 10, 2011 (DE) 10 2011 086 100.9

(51) Int. Cl. C04B 35/115; C04B 35/443; C04B 35/645

(52) U.S. Cl. CPC C04B 35/115; C04B 35/645; C04B 35/6455; C04B 35/443
USPC 264/1.21; 264/603; 264/667; 264/604

(57) ABSTRACT

A method for producing transparent ceramic objects having an RIT>10% in the wave length range of 300 nm to 4000 nm and a wall thickness of 2 mm. Said method consists of the following steps: producing a slip by dispersing a ceramic powder, the particle size of which is d50<5 μm, preferably between 5 nm and 500 nm; producing a granular material, the particle size of which is d50<1 mm, preferably between 50 μm and 500 μm, more preferably between 80 μm and 300 μm, from the slip by means of fluidised bed granulation; pressing the granular material in a simple, non-cyclical manner to form a green body; sintering the green body to form a sintered body; and re-densifying the sintered body.

The invention relates to a method for producing transparent ceramic objects with an RIT>10% in the wavelength range between 300 nm and 4000 nm with a 2 mm wall thickness of the ceramic objects.

Such ceramic objects may be used in ballistics, for example, because the desired transparency can be achieved with a high hardness at the same time. There are additional possibilities for use in the optical field, for example.

To protect vehicles such as military vehicles or civilian vehicles from gunfire, the vehicles are usually armor-plated. The armor plating is usually provided in the form of a metal system or a metal-ceramic system. However, such known systems are not suitable for the front windshields or side windows of motor vehicles or the like. These areas are usually furnished with bulletproof glass. However, bulletproof glass has a relatively low ballistic efficacy, in particular with respect to hardcore ammunition, which is why the window areas are the weak spots of a vehicle equipped in this way. Furthermore, bulletproof glass must be extremely heavy to ensure adequate protection.

Transparent ceramics have a better protective behavior, which is why there has been a search for alternatives to bulletproof glass. These alternatives have been discovered essentially in spinel and AlON. However, because of the very high processing temperatures that are required for these known materials they have a coarse crystalline structure—definitely with grain sizes of >1 μm or even >10 μm. Another shortcoming of these known alternatives is that they are very expensive because only a few parts can be produced in a manufacturing cycle that lasts several hours. It follows from this that the transparent ceramic objects produced in this way cost several times more than bulletproof glass. Despite the better properties of the known transparent ceramic objects, they have not yet succeeded in gaining a significant place on the market, i.e., so far they have been produced only on a laboratory scale.

Therefore, there has been an urgent need for a more economical method of producing transparent ceramic objects. In addition, it would also be desirable to improve the structural properties in comparison with coarse-crystalline hot-pressed material such as that used in the past. Such an improvement in the structural properties is described in EP 1 557 402 A2, for example, by gel casting. Gel casting is a wet shaping method. In addition to gel casting, other methods include slip casting, pressure casting and electrophoretic deposition (EPD). However, all these known methods require a complex drying and/or debinding. Furthermore, the surface quality of the ceramic objects produced in this way leaves much to be desired, which is why a complex surface aftertreatment is necessary.

Consequently, there is a desire for an uncomplicated economical production process for transparent ceramic objects. In view of their efficacy, pressing methods are recommended for this purpose in particular. So far, however, no ceramics have yet been produced by this technology in an economical process yielding the desired optical and mechanical properties. The reason for this is in particular the fact that the sinterability of the green body, which is determined essentially by the pore distribution and the pore volume, is too low. The pore volume and the pore distribution in particular are inferior with traditional press shaping in comparison with the wet shaping methods.

Granulation is also important, in addition to pressing, for the production of transparent ceramic objects. A defect-free material can be produced only if the granules are optimal.

The granules used in most cases are spray granules. Spray granules have a high pore content because of the production process and also have an irregular structure because the outer shell of the granules is exposed to much higher product temperatures than the center of the granules. Furthermore, water always diffuses out of the interior of the granules toward the outside, so there is a gradual density curve within the respective granules. In most cases, there is even a hollow area inside granules which cannot be made completely uniform by pressing the granules.

D. J. Kim, J. Y. Jung: “Granule performance of zirconia/alumina composite powders spray-dried using polyvinyl pyrrolidone binder,” J. E. Ceram Soc. 27 (2007) 3177-3182. This text describes solid granules based on spray granulation, but there is still always the problem of the different temperature exposure between the edge region and the central area of the granules. This results in a wide pore distribution.

Freeze granulation is one possibility for bypassing these problems; it yields granules that are very homogeneous and have a uniform structure and therefore produce good qualities in sintered ceramics. However, this technology has so far been used in the ceramic sector only on a laboratory scale and is not suitable for large-scale production. This method works with liquid nitrogen, which contributes to the high manufacturing cost. The material must then be freeze-dried in an additional process after spraying.

A method for producing a transparent ceramic having an RIT>40% in a relatively narrow wavelength range between 600 nm and 650 nm is known from DE 10 2007 059 091 A1 by the present applicant. This known method utilizes as the critical process step a cyclic pressing of the granules to form a green body. With this known method, a ceramic object that is transparent in the aforementioned wavelength range can be produced by cyclic pressing of any conventional ceramic granules produced by spray granulation, by freeze granulation or by fluidized bed granulation.

The object of the invention is to create a method of the type defined in the introduction, such that it is possible with the known process technology to produce ceramic objects that are transparent in a wide wavelength range by simple uniaxial or cold isostatic pressing of special ceramic granules.

This object is achieved according to the invention by the features of claim 1. Preferred embodiments and/or refinements of the method according to the invention are characterized in the dependent claims.

Ceramic objects produced according to the invention have an RIT>10%, for example, in a wavelength range between 600 nm and 700 nm, 1000 nm and 1400 nm and/or 2000 nm and 2400 nm with a wall thickness of 2 mm. Namely, it has surprisingly been found that it is possible by an essentially known method of fluidized bed granulation to create transparent ceramic objects of the aforementioned type. The particular feature here lies in the special properties of the fluidized bed granules and the effects of these special properties on the production of transparent ceramic objects—without requiring cyclic pressing of the granules, as disclosed in the above-referenced DE 10 2007 059 091 A1—for production of the corresponding green bodies.

The method according to the invention is also suitable in a particularly advantageous manner for production of transparent ceramic objects having ballistic protective properties. The transparent ceramic objects include vehicle windows or infrared radomes, for example.

It has surprisingly been found that the fluidized bed granulation has an optimization potential, which makes it possible to produce granules of a suitable quality in a freeze granulation process, which is very complex and therefore can be used only on a laboratory scale. It has surprisingly been found that the granules produced by means of the fluidized bed surprisingly have an improved deformation behavior and less porosity. A solid granular structure as well as a gradient-free structure of the granules are possible because there is no temperature gradient between the outer shell and the interior of the granule due to the granulation process according to the invention. Not only the solid granule but also the lack of a gradient due to the continuous structure make possible the special suitability of the granules produced by fluidized bed granulation according to the invention for transparent ceramic objects in an advantageous manner. The granules produced according to the invention exhibit an optimal behavior in pressing of the green bodies for the transparent ceramic objects—regardless of the ceramic powder used—so that, in contrast with cyclic pressing according to DE 10 2007 059 091 A1, a simple non-cyclic pressing of the granules is possible and/or takes place in a particularly advantageous manner. Furthermore, a low residual porosity of <0.1% for the usual nontransparent ceramics hardly yields any advantages with regard to their properties. With the transparent ceramics, however, the residual porosity constitutes the difference between opacity and transparency. The special suitability of the process according to the invention for the production of transparent ceramic objects is derived from this.

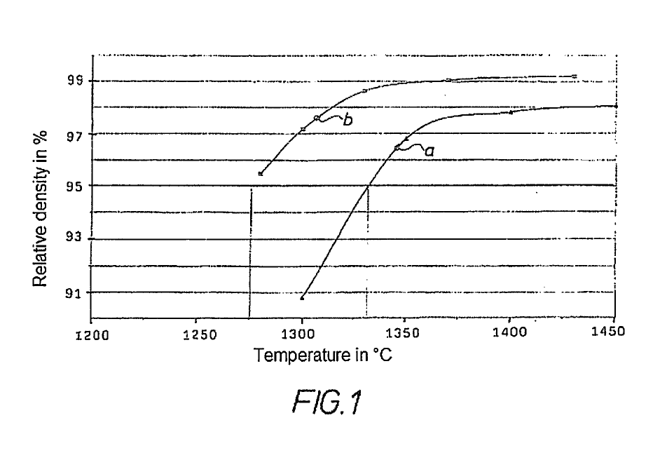

These general advantages can already be observed, even at lower temperatures and densities, with conventional powders that are not suitable for transparent ceramic objects, as indicated by the following table and the accompanying FIG. 1, where the curve “a” indicates the functional relationship between the relative sintered density and the temperature of a reference spray granule, and the curve “b” shows the corresponding functional relationship of a fluidized bed granular product according to the invention.

According to the invention, a density of >99% can be achieved even at comparatively lower temperatures. These density values of >99% cannot be achieved with the reference spray granules, even at a temperature of 1600° C.

TABLE

| | | Relative density | Relative density |
|---|---|---|---|
| | Relative density | (sintered) | (sintered) |
| Granules | (green) | 1300° C. | 1400° C. |
| Fluidized bed | 59.8 | 97.2 | 99.1 |
| granules | | | |
| batch 1 | | | |
| Spray granules, | 58.3 | 90.5 | 98.2 |
| optimized | | | |
| reference | | | |

According to the invention, it is possible to reduce the width of the pore distribution and thus increase the homogeneity. The large pores in particular disappear. As FIG. 1 shows, the dense sintering temperature is lowered by more than 50° C. according to the invention. Furthermore, a greater total compaction is possible. This is essential for a transparent ceramic. According to the invention, the required homogeneity can be achieved in an advantageous manner by simple, conventional non-cyclic pressing. In addition, the fluidized bed method is suitable for granulating, for example, more than 2000 tons per year in a plant without any problems so as to yield suitability for mass production.

The fluidized bed method which is used according to the present invention surprisingly offers the best suitability for production of transparent ceramic objects through simple non-cyclic pressing of the granules produced by fluidized bed granulation to form a green body. Fluidized bed granulation is the only method that solves the problem of efficacy and suitability for mass production by simple non-cyclic pressing and results in the desired material properties.

The molded green body is then sintered and next compacted. For this purpose, the green body may either be pre-sintered and sintered and hot isostatic pressed, HIP, or just sintered first until developing a closed porosity and then HIP is again performed subsequently.

For the final preparation, the sintered body can be ground and then polished to the desired optical quality, so as to yield RIT values of >10%.

The present invention includes all ceramic objects produced by means of the method according to the invention. The geometric shapes of the transparent ceramic objects produced according to the invention are determined by the possibilities of green processing such as CNC milling, cutting, turning or the like.

The variable responsible for the transparency of the ceramic objects produced in this way is the “real” in-line transmission (RIT), which is to be measured only with a very narrow aperture angle of approx. 0.5 DEG for the purpose of excluding scattered light from the detected intensity, said RIT being determined with light of a wavelength of 640 nm (red), for example.

Ceramic objects produced according to the invention are made of a transparent polycrystalline ceramic, which, more or less, has no glass phase (<0.1%) and has a theoretical density of >99.5%, preferably ?99.9%.

In the method according to the invention, it is possible to use any ceramic materials that have hardness values of GPa and are transparent with a porosity of ≦0.1%. Preferred examples include aluminum oxide, spinels (MgAl₂O₄, etc.), AlON, perovskite (e.g., YAlO₃) or garnet (e.g., Y₃Al₅O₁₂). The only prerequisite is that the starting materials must have a purity of ≧99% and a starting grain size of ≦1000 μm, preferably ≦300 nm. The ceramic should have almost no porosity (≦0.1%) to ensure RIT values of ≧10%. This is the definite difference in comparison with the known “translucent” ceramics, which are produced by molding as described in EP 1 458 304 A1, for example.

The granules produced by fluidized bed granulation according to the invention are shaped to form the green body desired in each respective case by dry pressing or by isostatic pressing or a combination of the two. Next they are sintered and post-compacted. Post-compacting is preferably performed by hot isostatic pressing (HIP). The HIP process may be performed in various sintering atmospheres, such as argon or air, or in a vacuum.

Alternatively, the green body may also be pre-sintered by a conventional method and then subjected to the HIP process. The sintering temperature and HIP temperature depend on the raw material and the molding. To achieve the desired transparency, a post-HIP process is necessary in the case of pre-sintering. The entire sintering process is performed in a HIP oven in the case of sintering/hot isostatic pressing, HIP.

The present invention is described in further detail below on the basis of two examples.

### EXAMPLE 1

Spinel powder is processed to form a 50% by weight slip. The highly fluid slip having a low viscosity is then sprayed by means of an eccentric screw pump into a fluidized bed granulation system. The pure powder had been added to the system previously as a powder bed. The material is slowly and continuously granulated through a slow and continuous slip feedstream. The pressure conditions and the incoming air are adjusted, so that granules can be produced in the size range between d10=100 μm and d90=300 μm. Granules produced in this way are solid granules, such as a hollow spherical structure or a doughnut shape, without any inhomogeneities. The granules are then pressed uniaxially at 160 MPa to form a sheet with the dimensions 50 mm×50 mm, which can be thoroughly sintered at 1500° C. due to its homogeneity. Next a HIP process is also performed at 1500° C. and 2000 bar. A measured density of 3.575 g/cm³ is obtained after the HIP process, determined in accordance with DIN EN 623-2 according to the Archimedean method. This represents a density of >99.9%. An RIT value of 83% with 0.2% fluctuation within the sheet produced is obtained from the high homogeneous density.

### EXAMPLE 2

Aluminum oxide powder is milled using an agitated ball mill and is processed further with suitable additives to form a 60% by weight slip. The low-viscosity slip is then sprayed by means of an eccentric screw pump into a fluidized bed granulation system. The pure powder is added as a powder bed to the system in advance. The material is granulated slowly and continuously by a slow and continuous slip feed stream. The pressure conditions as well as the incoming air are adjusted to produce granules in the size range between d10=80 μm and d90=250 μm. The granules produced in this way are solid granules, such as a hollow spherical structure or a doughnut shape, without any inhomogeneities. The granules produced in this way are then pressed uniaxially at 150 MPa to form a sheet with the dimensions 50 mm×50 mm, which can then be sintered thoroughly at 1230° C. due to its homogeneity. Next a HIP process is also performed at 1200° C. and 2000 bar. A measured density of >3.98 g/cm³ is obtained after the HIP process. This represents a density of >99.9%. A RIT value of >40% is obtained from the high, homogeneous density with a wall thickness of

1.-7. (canceled)

8. A method for producing transparent ceramic objects with an RIT>10% in the wavelength range of 300 nm to 4000 nm with a wall thickness of the ceramic objects of 2 mm, comprising the steps of:
producing a slip by dispersing a ceramic powder having a particle size d50 of <5 μm;
producing from the slip granules having a particle size d50 of <1 mm, wherein said producing is via fluidized bed granulation;
simple non-cyclic pressing the granules to form a green body;
sintering the green body to form a sintered body; and
post-compacting the sintered body.

9. The method according to claim 8, wherein the dispersing of the ceramic powder is performed using water and surface-active substances.

10. The method according to claim 8, further comprising the step of milling the ceramic powder while being dispersed.

11. The method according to claim 10, wherein the dispersion and milling of the ceramic powder are performed in an agitated mill.

12. The method according to claim 8, wherein the green body is molded by uniaxial pressing.

13. The method according to claim 8, wherein the green body is molded by isostatic pressing.

14. The method according to claim 8, wherein the post-compaction is performed by hot isostatic pressing

15. The method according to claim 8, further comprising grinding the sintered body and polishing the sintered body to an optical quality.
